(19) United States
(12) Patent Application Publication
(10) Pub. No.: US 2024/0408835 A1
(43) Pub. Date: Dec. 12, 2024

(54) PLASTIC LENS AND MOLDING APPARATUS FOR MANUFACTURING PLASTIC LENS

(71) Applicant: Samsung Electro-Mechanics Co., Ltd., Suwon-si (KR)

(72) Inventors: Hae Sung OH, Suwon-si (KR); Ae Rim KIM, Suwon-si (KR); Sang Hyeon HONG, Suwon-si (KR); Sang A KIM, Suwon-si (KR); Sang Hyun KWON, Suwon-si (KR); Seong Chan PARK, Suwon-si (KR)

(73) Assignee: Samsung Electro-Mechanics Co., Ltd., Suwon-si (KR)

(21) Appl. No.: 18/439,100

(22) Filed: Feb. 12, 2024

(30) Foreign Application Priority Data
Jun. 12, 2023 (KR) 10-2023-0075104

(51) Int. Cl. B29D 11/00; B29C 43/02; B29C 43/52; B29L 11/00

(52) U.S. Cl. CPC B29D 11/00413; B29C 43/02; B29C 43/52; B29L 2011/0016

(57) ABSTRACT

A plastic lens and a molding apparatus for manufacturing the plastic lens are provided. The plastic lens includes an optical portion that refracts light and a flange portion that extends from the optical portion, wherein a parting line is continuously formed along a circumference of the flange portion on a side surface of the flange portion. The molding apparatus includes a first mold including a first core portion and a first body portion which accommodates the first core portion, a second mold including a second core portion and a second body portion which accommodates the second core portion, and a third mold including a third body portion coupled to a first surface of the second body portion that faces the first body portion.

### CROSS-REFERENCE TO RELATED APPLICATIONS

This application claims the benefit under 35 USC § 119 (a) of Korean Patent Application No. 10-2023-0075104 filed on Jun. 12, 2023, in the Korean Intellectual Property Office, the entire disclosure of which is incorporated herein by reference for all purposes.

### BACKGROUND

### 1. Field

The following description relates to a plastic lens and a molding apparatus for manufacturing the plastic lens.

### 2. Description of Related Art

Typically, lenses that are implemented in the camera modules of portable electronic devices, such as, but not limited to, smartphones, are plastic lenses, and such plastic lenses are manufactured by an injection molding process.

That is, an injection mold has a cavity corresponding to the shape of a lens, and a plastic lens is manufactured by injecting molten resin into the cavity.

However, in the example of the injection molding method, there may be a problem that residual stress may occur in a gate portion for supplying the molten resin to the cavity, thereby deteriorating the optical performance of the lens.

Additionally, the rates at which the molten resin flows are different in portions of the cavity, and as a result, flow marks or weld lines may occur on the lens, reducing the optical performance of the lens.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a plastic lens includes an optical portion that refracts light; and a flange portion that extends from the optical portion, wherein a parting line is continuously formed along a circumference of the flange portion on a side surface of the flange portion.

T_max/T_min>3.0, where T_max is a largest thickness of the optical portion, and T_min is a smallest thickness of the optical portion.

A diameter of the plastic lens may be 10 mm or greater.

One or more cutting portions may be disposed on an edge of the flange portion, and the one or more cutting portions may have a larger birefringence than other portions of the edge of the flange portion.

A plurality of cutting portions may be provided, and the plurality of cutting portions may be spaced apart from each other along the circumference of the flange portion.

In a general aspect, a molding apparatus for manufacturing a plastic lens includes a first mold including a first core portion and a first body portion which accommodates the first core portion; a second mold including a second core portion and a second body portion which accommodates the second core portion; and a third mold including a third body portion coupled to a first surface of the second body portion that faces the first body portion, wherein the first mold is configured to be movable with respect to the second mold and the third mold, wherein the first mold is configured to move to a position that is closer to the first surface of the second body portion than to the a first surface of the third body portion that faces the first body portion, and wherein, when the first mold is moved, a cavity that is surrounded by the first core portion, the second core portion, the second body portion, and the third body portion is formed.

The third body portion may include one or more recess portions, and the first surface of the third body portion is a bottom surface of the one or more recess portions.

The one or more recess portions may be provided in plural, and the plurality of recess portions are spaced apart from each other in a circumferential direction.

A first surface of the second core portion may be located lower than the first surface of the second body portion, and a first surface of the first core portion that faces the first surface of the second core portion may be configured to move to be located between the first surface of the second body portion and the first surface of the third body portion.

When the cavity is formed, a distance between an outer end of the first surface of the first core portion and an outer end of the first surface of the second core portion may be less than a distance between an outer end of the first surface of the second core portion and the first surface of the third body portion.

0.1≤T1/T2<1 is satisfied, where T1 is the distance between the outer end of the first surface of the first core portion and the outer end of the first surface of the second core portion, and T2 is the distance between the outer end of the first surface of the second core portion and the first surface of the third body portion.

The one or more recess portions may be formed to have a greater volume at an upper end of the one or more recess portions than at a lower end of the one or more recess portions.

The first body portion and the second body portion may be each provided with a first heating unit configured to generate heat, and a flow path through which fluid flows.

A second heating unit configured to generate heat may be coupled to each of the first core portion and the second core portion.

In a general aspect, a molding apparatus for manufacturing a plastic lens includes a first movable mold comprising a first core portion and a first body portion which accommodates the first core portion; a second mold comprising a second core portion and a second body portion which accommodates the second core portion; and a third mold comprising one or more recess portions and a third body portion coupled to a first surface of the second body portion that faces the first body portion, a third mold comprising one or more recess portions and a third body portion coupled to a first surface of the second body portion that faces the first body portion, wherein a portion of the raw material that exceeds a weight of the plastic lens is discharged from the cavity into the one or more recess portions when the first mold is moved toward the second mold.

Other features and aspects will be apparent from the following detailed description, the drawings, and the claims.

### BRIEF DESCRIPTION OF DRAWINGS

FIG. 1 illustrates a method of manufacturing a plastic lens, in accordance with one or more embodiments.

FIG. 2 illustrates a plastic raw material being seated in a second mold.

FIG. 3 illustrates a first mold being moved.

FIG. 4 illustrates a state in which a plastic raw material is heated and pressed by a mold.

FIG. 5 is an enlarged view of portion A of FIG. 4.

FIG. 6 illustrates a state in which a molded lens is separated from a mold.

FIG. 7 illustrates a state in which a plastic raw material discharged to the outside of a cavity during a lens molding process is removed from a mold.

FIGS. 8A, 8B, 8C, and 8D are plan views illustrating various examples of a second mold and a third mold.

FIGS. 9A, 9B, and 9C are cross-sectional views of various examples of a recess portion.

FIG. 10 is a plan view of a plastic lens, in accordance with one or more embodiments.

FIG. 11 illustrates a perspective view of a plastic lens, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

One or more examples may provide a plastic lens that improves optical performance and a molding apparatus for manufacturing the plastic lens.

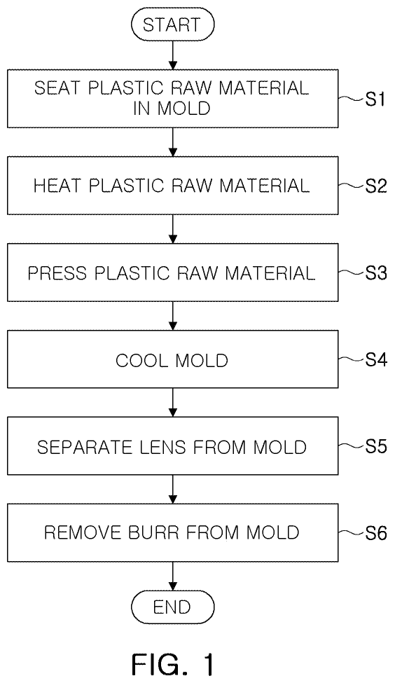

FIG. 1 illustrates a method of manufacturing a plastic lens, in accordance with one or more embodiments. In the following examples, operations may be performed sequentially but are not limited thereto. In an example, the order of the operations may be changed, and at least two operations may be performed in parallel.

Referring to FIG. 1, the method of manufacturing a plastic lens, in accordance with one or more embodiments, includes a first operation (operation S1).

The first operation (operation S1) may be an operation of seating a plastic raw material in a mold for manufacturing a plastic lens (hereinafter referred to as a ‘mold’). A weight of the plastic raw material may be greater than a weight of the lens to be manufactured.

The method of manufacturing a plastic lens, in accordance with one or more embodiments, includes a second operation (operation S2). The second operation (operation S2) may be an operation of heating the plastic raw material seated in the mold.

In the second operation (operation S2), the plastic raw material may be heated to a temperature above a glass transition temperature Tg of the plastic raw material. Since the plastic raw material is heated to a temperature above the glass transition temperature Tg, the plastic raw material has fluidity in the second operation (operation S2).

The method of manufacturing a plastic lens, in accordance with one or more embodiments, includes a third operation (operation S3). The third operation (operation S3) may be an operation of pressing the plastic raw material.

The plastic raw material may be pressed while being heated to a temperature above the glass transition temperature Tg of the plastic raw material.

Since the plastic raw material is heated to have fluidity, the plastic raw material may be pressed and molded to have a shape corresponding to a shape of the cavity.

In FIG. 1, the third operation (operation S3) is shown as being performed after the second operation (operation S2). However, in order to shorten the cycle of the lens manufacturing process, the second operation (operation S2) and the third operation (operation S3) may be performed simultaneously.

Since a total weight of the plastic raw material is greater than a weight of the lens to be manufactured, a portion of the plastic raw material may be discharged from the cavity as the plastic raw material is pressed by the mold.

The method of manufacturing a plastic lens, in accordance with one or more embodiments, includes a fourth operation (operation S4). The fourth operation (operation S4) may be an operation of cooling the mold.

In the fourth operation (operation S4), the mold may be cooled below the glass transition temperature Tg. Accordingly, the lens molded within the cavity of the mold may also be cooled.

The method of manufacturing a plastic lens, in accordance with one or more embodiments, includes a fifth operation (operation S5). The fifth operation (operation S5) may be an operation of separating the lens from the mold.

In the fifth operation (operation S5), the molded lens may be separated from the mold and stored separately.

The method of manufacturing a plastic lens, in accordance with one or more embodiments, may include a sixth operation (operation S6). The sixth operation (operation S6) may be an operation of removing a portion (burr) of the plastic raw material discharged to the outside of the cavity in the third operation (operation S3) from the mold.

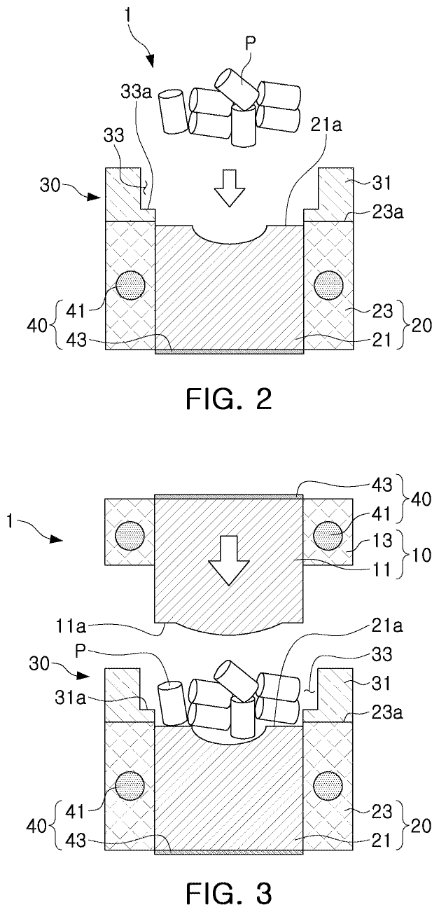

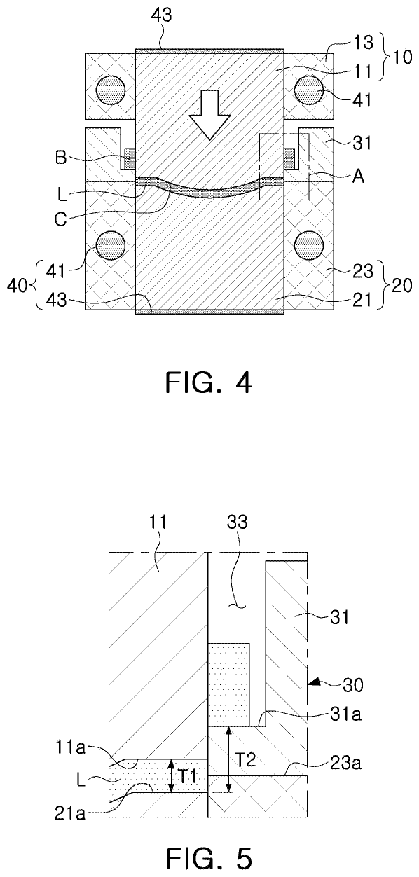

FIG. 2 illustrates the plastic raw material being seated in a second mold. FIG. 3 illustrates a first mold being moved. FIG. 4 illustrates an example in which a plastic raw material is heated and pressed by a mold. FIG. 5 illustrates an enlarged view of portion A of FIG. 4.

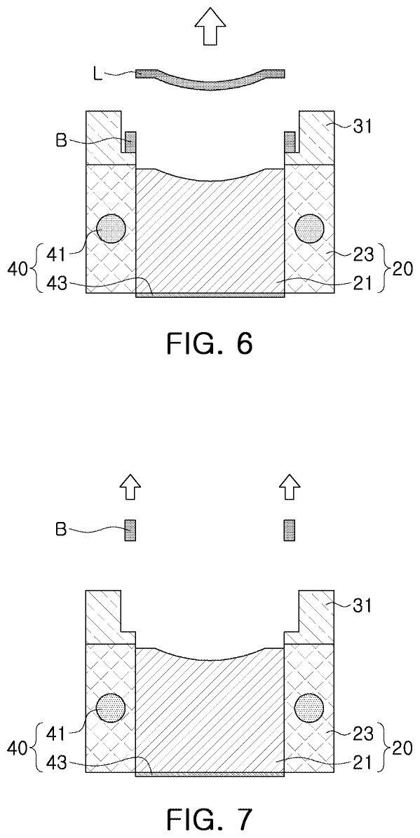

Additionally, FIG. 6 illustrates an example in which a molded lens is separated from a mold, and FIG. 7 illustrates an example in which a plastic raw material is discharged to the outside of a cavity during a lens molding process from a mold.

Referring to FIGS. 2 to 7, a manufacturing process of the plastic lens L and a manufacturing mold 1 will be described in detail.

First, referring to FIGS. 2 and 3, the mold 1 includes a first mold 10, a second mold 20, and a third mold 30. The first mold 10 may be a movable mold, and the second mold 20 and the third mold 30 may be fixed molds.

The first mold 10 includes a first core portion 11 and a first body portion 13. The first body portion 13 is provided with an accommodating space in which the first core portion 11 is accommodated, and, in an example, the accommodating space may be in the shape of a hole or recess portion.

The first core portion 11 is accommodated in the first body portion 13. One surface 11a of the first core portion 11 may have a shape corresponding to a shape of the plastic lens L to be manufactured.

In an example, one surface 11a of the first core portion 11 may have a shape corresponding to an object-side surface of the plastic lens L being manufactured.

The second mold 20 includes a second core portion 21 and a second body portion 23. The second body portion 23 is provided with an accommodating space in which the second core portion 21 is accommodated, and, in an example, the accommodating space may be in the shape of a hole or recess portion.

The second core portion 21 is accommodated in the second body portion 23. One surface 21a of the second core portion 21 may have a shape corresponding to the shape of the plastic lens L being manufactured.

In an example, one surface 21a of the second core portion 21 may have a shape corresponding to an image-side surface of the plastic lens L being manufactured.

The first body portion 13 and the second body portion 23 may be disposed to face each other, and the first core portion 11 and the second core portion 21 may be disposed to face each other.

One surface 21a of the second core portion 21 may be located below one surface 23a of the second body portion 23 facing the first body portion 13.

The third mold 30 includes a third body portion 31. The third body portion 31 is coupled to one surface 23a of the second body portion 23 facing the first body portion 13.

When the first mold 10 is moved and joined with the second mold 20 and the third mold 30, a cavity C surrounded by the first mold 10, the second mold 20, and the third mold 30 may be formed. For example, a space that is surrounded by one surface 11a of the first core portion 11, one surface 21a of the second core portion 21, an internal surface of the second body portion 23, and an internal surface of the third body portion 31 may define the cavity C.

The cavity C may be a space in which the plastic lens L is molded.

A plastic raw material P is seated in the mold 1. Here In an example, the plastic raw material P may be a material for manufacturing the plastic lens L, and may be a thermoplastic resin material. In an example, the plastic raw material P may be a resin material in the form of a pellet.

A weight of the plastic raw material P may be greater than a weight of the plastic lens L to be manufactured.

The plastic raw material P may be seated on one surface 21a of the second core portion 21 of the second mold 20, which is a fixed mold.

When the plastic raw material P is seated in the second core portion 21 of the second mold 20, the plastic raw material P is heated by the second mold 20. For example, the plastic raw material P may be heated to a temperature higher than the glass transition temperature Tg of the plastic raw material P.

Accordingly, heating units 40 that generate heat may be disposed in the first mold 10 and the second mold 20, respectively. The heating unit 40 includes a first heating unit 41 which heats the first body portion 13, and the second body portion 23. Additionally, the heating unit 40 may include a second heating unit 43 which heats the first core portion 11 and the second core portion 21.

The mold 1 may be equipped with a temperature sensor, and a temperature of the mold 1 (or a temperature of the plastic raw material P) may be measured by the temperature sensor.

The first heating unit 41 may be disposed on the first body portion 13 and the second body portion 23 to heat the respective first body portion 13 and the second body portion 23. Accordingly, the first core portion 11 accommodated in the first body portion 13 and the second core portion 21 accommodated in the second body portion 23 may also be heated. That is, the first heating unit 41 may indirectly heat the first core portion 11 and the second core portion 21.

The second heating unit 43 may be disposed in a position to heat the first core portion 11 and the second core portion 21. The second heating unit 43 may be disposed around the first core portion 11 and around the second core portion 21.

For example, the second heating unit 43 may be disposed in an upper portion of the first core portion 11 and in a lower portion the second core portion 21. In an example, the upper portion of the first core portion 11 may refer to the opposite side of one surface 11a of the first core portion 11, and the lower portion of the second core portion 21 may refer to the opposite side of one surface 21a of the second core portion 21.

In an example, before the plastic raw material P is seated on the second core portion 21, the second core portion 21 may be preheated by one or more of the first heating unit 41 and the second heating unit 43.

Therefore, since a heating time for the plastic raw material P to become fluid may be shortened, a manufacturing time of the plastic lens L may be shortened and productivity may be improved.

Additionally, the first core portion 11 may also be preheated by one or more of the first heating unit 41 and the second heating unit 43.

Referring to FIGS. 3 to 5, the first mold 10 may be moved and joined with the second mold 20 and the third mold 30. The first mold 10, which is a movable mold, moves toward the second mold 20 and the third mold 30, which are fixed molds, and the cavity C is formed between the movable mold 10 and the fixed molds 20 and 30.

The cavity C may be defined as a space surrounded by the first core portion 11 of the first mold 10, the second core portion 21 of the second mold 20, an internal surface of the second body portion 23 of the second mold 20, and an internal surface of the third body portion 31 of the third mold 30.

The plastic raw material P disposed in the second core portion 21 of the second mold 20 may be pressed as the first mold 10 moves. At this time, the plastic raw material P may be heated by the first mold 10 and the second mold 20 to have fluidity, and thus, the plastic raw material P may be pressed according to the shape of the cavity C.

In an example, since the weight of the plastic raw material P may be greater than the weight of the plastic lens L to be manufactured, the excess weight should be discharged to the outside of the cavity C.

In an example, the first mold 10 is moved to a position that is closer to one surface 23a of the second body portion 23 than to the one surface 31a of the third body portion 31 facing the first body portion 13.

In an example in which the first mold 10 is joined with the second mold 20 and the third mold 30, one surface 11a of the first core portion 11 of the first mold 10 is located between one surface 23a of the second body portion 23 of the second mold 20 and one surface 31a of the third body portion 31.

The third mold 30 may have one or more recess portions 33 which have, as a bottom surface, one surface 31a of the third body portion 31 facing the first body portion 13. One or more recess portions 33 may be open toward the second core portion 21.

In an example in which the first mold 10 is joined with the second mold 20 and the third mold 30, a side surface of the first core portion 11 of the first mold 10 is in contact with the internal surface of the third body portion 31.

Accordingly, as the first mold 10 is moved, a portion B of the plastic raw material P exceeding the weight of the plastic lens L to be manufactured is discharged to the outside of the cavity C through one or more recess portions 33.

Additionally, when one surface 11a of the first core portion 11 of the first mold 10 moves downwardly, relative to the one surface 31a of the third body portion 31, the plastic raw material P disposed in the cavity C and the portion B of the plastic raw material P discharged to the outside of the cavity C are separated from each other.

Referring to FIG. 5, in an example in which the first mold 10 is joined with the second mold 20 and the third mold 30, a distance T1 between an outer end of one surface 11a of the first core portion 11 and an outer end of one surface 21a of the second cord portion 21 may be less than a distance T2 between the outer end of one surface 21a of the second core portion 21 and one surface 31a of the third body portion 31.

In an example, 0.1≤T1/T2<1 may be satisfied.

When molding of the plastic lens L is completed, the mold 1 may be cooled. In an example, mold 1 may be cooled below the glass transition temperature Tg. Accordingly, the plastic lens L molded within the cavity C of the mold 1 may also be cooled. When cooling is completed, the first mold 10 is separated from the second mold 20 and the third mold 30.

Cooling of the mold 1 may be achieved by supplying fluid into the mold 1. In a non-limited example, the fluid may be air or water. Accordingly, a flow path for cooling the mold 1 may be disposed in the mold 1. In an example, the flow path may be provided in the first body portion 13 of the first mold 10 and the second body portion 23 of the second mold 20.

Thereafter, the molded plastic lens L may be removed from the mold 1 and stored separately, and when the removal of the plastic lens L is completed, the portion B of the plastic raw material P filling one or more recess portions 33 may be removed from the mold 1.

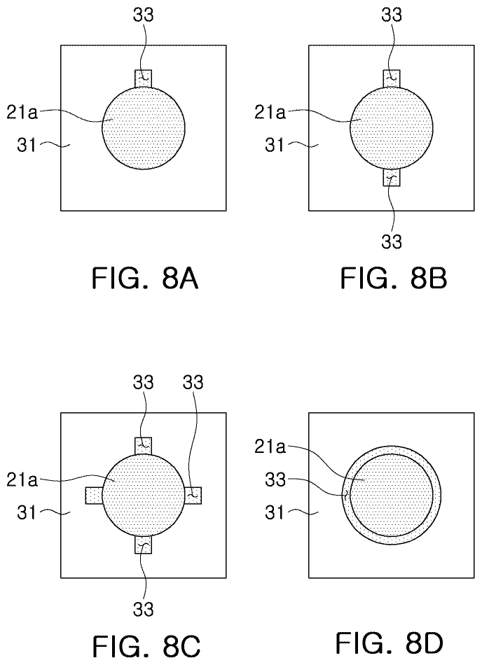

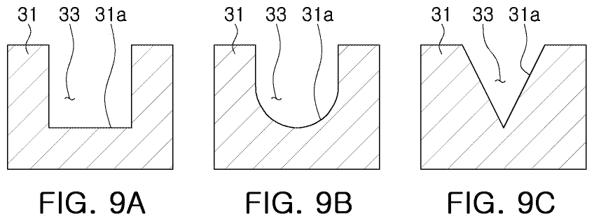

FIGS. 8A to 8D are plan views of various examples of the second mold and the third mold, and FIGS. 9A to 9C are cross-sectional views of various examples of a recess portion.

Referring to FIGS. 8A to 8D, one or more recess portions 33 are formed in the third body portion 31 and upper and side portions of the recess portions 33 may be open.

In an example, the upper portion of the recess portion 33 may be open toward the first body portion 13, and one side portion of the recess portion 33 may be open toward the second core portion 21.

When a plurality of recess portions 33 are provided, the plurality of recess portions 33 may be disposed to be spaced apart from each other along the circumference of the second core portion 21.

Referring to FIGS. 9A to 9C, the recess portion 33 may accommodate the portion B of the plastic raw material P discharged to the outside of the cavity C, while the plastic raw material P is pressed.

In an example, a lower width of the recess portion 33 may be less than an upper width of the recess portion 33. In an example, the width of the recess portion 33 may increase linearly or non-linearly from the bottom of the recess portion 33 to the top of the recess portion 33.

When the lower width of the recess portion 33 is less than the upper width of the recess portion 33, the amount of plastic raw material P discharged to the outside of the cavity C may decrease as the first mold 10 is moved to press the plastic raw material P, which may be advantageous for precise weight control of the plastic lens L.

The plastic lens L, in accordance with one or more embodiments, may be formed of plastic and may be manufactured through a heating and pressing method rather than a typical injection molding method.

Typically, when lenses are manufactured by injection molding, residual stress may occur in a gate portion, which is a passage for a molten resin, resulting in a degradation of optical performance. Additionally, since the gate should be removed from the injection molded lens, the manufacturing process may increase and there is a risk that the lens may be damaged during the gate removal process.

Additionally, since the lens may have a curved shape rather than a flat shape, there is a variation in thickness for each portion of the cavity of the injection mold. Accordingly, there is a difference in a rate at which the molten resin flows, which causes flow marks or weld lines in the injection molded lens, resulting in a degradation of the optical performance.

However, since the plastic lens L, in accordance with one or more embodiments, is manufactured by heating and pressing the plastic raw material P in a pellet state, the problems occurring during injection molding may be solved.

In an example, the plastic lens L, in accordance with one or more embodiments, may prevent flow marks and weld lines from being created, and may also prevent a degradation of optical performance (e.g., high birefringence) due to residual stress.

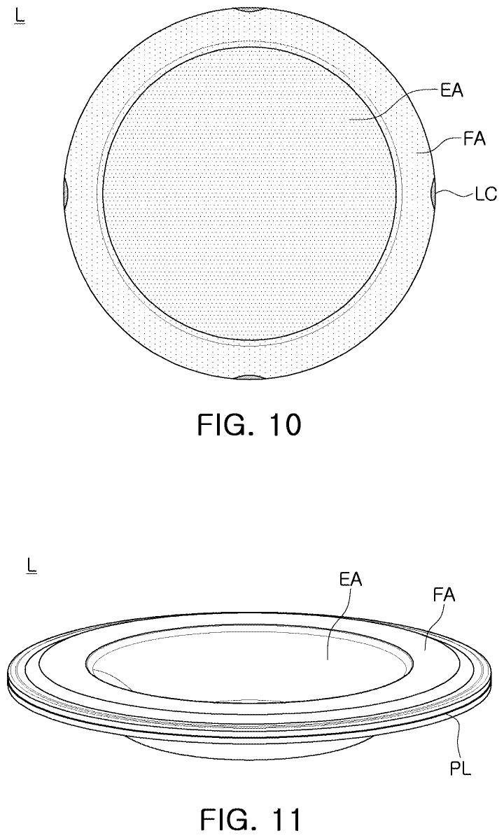

FIG. 10 is a plan view of an example plastic lens, in accordance with one or more embodiments, and FIG. 11 is a perspective view of an example plastic lens, in accordance with one or more embodiments.

Referring to FIGS. 10 and 11, the plastic lens L, in accordance with one or more embodiments, includes an optical portion EA and a flange portion FA. The optical portion EA may be a portion in which the optical performance of the plastic lens Lis demonstrated. In an example, light reflected from a subject may be refracted, while passing through the optical portion EA.

In an example, the plastic lens L, in accordance with one or more embodiments, may have a diameter of 10 mm or greater. In an example, the diameter may be the overall diameter of the plastic lens L including the optical portion EA and the flange portion FA.

The optical portion EA may have refractive power and may have an aspherical shape.

Additionally, the optical portion EA includes an object-side surface (a surface facing an object side) and an image-side surface (a surface facing an image side).

The plastic lens L may have thicknesses that are different for each portion of the plastic lens L. In an example, the object-side surface and the image-side surface of the optical portion EA may have different curvatures. In an example, the thickness refers to a thickness in an optical axis direction.

The plastic lens L, in accordance with one or more embodiments, may have a ratio of 3.0 or more between the thickest portion and the thinnest portion of the optical portion EA. For example, T_max/T_min>3.0. Here, T_max denotes the largest thickness of the optical portion EA, and T_min denotes the smallest thickness of the optical portion EA.

The flange portion FA may be a portion that fixes the plastic lens L to another component, for example, a lens barrel or another lens.

The flange portion FA may extend from the optical portion EA, and may be formed integrally with the optical portion EA.

When the plastic lens L is manufactured by injection molding, the manufactured plastic lens L may have problems, such as flow marks and weld lines or high birefringence.

However, since the plastic lens L, in accordance with one or more embodiments, is manufactured by heating and pressing a plastic raw material in the form of pellets, the degradation of optical performance (occurrence of flow marks and weld lines, high birefringence, etc.) occurring in existing plastic injection lenses may be prevented. Therefore, optical performance may be improved.

In the process of manufacturing the plastic lens L, since the plastic raw material P is pressed within the mold 1, the portion B of the plastic raw material P is discharged to the outside of the cavity C. Then, the plastic raw material P discharged to the outside by the movement of the first mold 10 is cut from the plastic lens L.

Accordingly, the plastic lens L has one or more cutting portions LC at the edge of the flange portion FA. The cutting portion LC is formed in a position where the plastic raw material P is separated.

The cutting portion LC may have greater birefringence compared to other portions of the flange portion FA. In an example, the birefringence of the cutting portion LC may be greater than the birefringence of other portions of the edge of the flange portion FA.

However, the birefringence of the cutting portion LC may be significantly smaller than the birefringence at the gate portion of a general plastic injection lens.

When a plurality of cutting portions LC are provided, the plurality of cutting portions LC may be spaced apart from each other along the circumference of the flange portion FA.

In an example, a parting line PL may be continuously formed on a side surface of the flange portion FA of the plastic lens L along the circumference of the flange portion FA. The parting line PL may be a shape formed by surfaces of different molds coming into contact with each other.

In an example, referring to FIG. 5, the side surface of the flange portion FA of the plastic lens L may correspond to the internal surface of the second body portion 23 of the second mold 20 and the internal surface of the third body portion 31 of the third mold 30.

Accordingly, the parting line PL may be formed continuously along the circumference of the flange portion FA on the side surface of the flange portion FA corresponding to the portion in which the second body portion 23 and the third body portion 31 are in contact with each other.

According to the plastic lens and the molding apparatus for manufacturing the plastic lens, in accordance with one or more embodiments, the optical performance of the lens may be improved.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A plastic lens, comprising:
an optical portion that refracts light; and
a flange portion that extends from the optical portion,
wherein a parting line is continuously formed along a circumference of the flange portion on a side surface of the flange portion.

2. The plastic lens of claim 1, wherein T_max/T_min>3.0, where T_max is a largest thickness of the optical portion, and T_min is a smallest thickness of the optical portion.

3. The plastic lens of claim 1, wherein a diameter of the plastic lens is 10 mm or greater.

4. The plastic lens of claim 1, wherein:
one or more cutting portions are disposed on an edge of the flange portion, and
the one or more cutting portions have a larger birefringence than other portions of the edge of the flange portion.

5. The plastic lens of claim 4, wherein a plurality of cutting portions are provided, and the plurality of cutting portions are spaced apart from each other along the circumference of the flange portion.

6. A molding apparatus for manufacturing a plastic lens, the molding apparatus comprising:
a first mold comprising a first core portion and a first body portion which accommodates the first core portion;
a second mold comprising a second core portion and a second body portion which accommodates the second core portion; and
a third mold comprising a third body portion coupled to a first surface of the second body portion that faces the first body portion,
wherein the first mold is configured to be movable with respect to the second mold and the third mold,
wherein the first mold is configured to move to a position that is closer to the first surface of the second body portion than to a first surface of the third body portion that faces the first body portion, and
wherein, when the first mold is moved, a cavity that is surrounded by the first core portion, the second core portion, the second body portion, and the third body portion is formed.

7. The molding apparatus of claim 6, wherein the third body portion comprises one or more recess portions, and the first surface of the third body portion is a bottom surface of the one or more recess portions.

8. The molding apparatus of claim 7, wherein the one or more recess portions is provided in plural, and the plurality of recess portions are spaced apart from each other in a circumferential direction.

9. The molding apparatus of claim 7, wherein:
a first surface of the second core portion is located lower than the first surface of the second body portion, and
a first surface of the first core portion that faces the first surface of the second core portion is configured to move to be located between the first surface of the second body portion and the first surface of the third body portion.

10. The molding apparatus of claim 9, wherein, when the cavity is formed, a distance between an outer end of the first surface of the first core portion and an outer end of the first surface of the second core portion is less than a distance between an outer end of the first surface of the second core portion and the first surface of the third body portion.

11. The molding apparatus of claim 10, wherein 0.1≤T1/T2<1 is satisfied, where T1 is the distance between the outer end of the first surface of the first core portion and the outer end of the first surface of the second core portion, and T2 is the distance between the outer end of the first surface of the second core portion and the first surface of the third body portion.

12. The molding apparatus of claim 7, wherein the one or more recess portions are formed to have a greater volume at an upper end of the one or more recess portions than at a lower end of the one or more recess portions.

13. The molding apparatus of claim 6, wherein the first body portion and the second body portion are each provided with a first heating unit configured to generate heat, and a flow path through which fluid flows.

14. The molding apparatus of claim 13, wherein a second heating unit configured to generate heat is coupled to each of the first core portion and the second core portion.

15. A molding apparatus for manufacturing a plastic lens, the molding apparatus comprising:
a first movable mold comprising a first core portion and a first body portion which accommodates the first core portion;
a second mold comprising a second core portion and a second body portion which accommodates the second core portion; and
a third mold comprising one or more recess portions and a third body portion coupled to a first surface of the second body portion that faces the first body portion,
wherein a cavity, configured to seat a raw material, is formed between the first mold and the second mold based on a movement by the first mold toward the second mold, and
wherein a portion of the raw material that exceeds a weight of the plastic lens is discharged from the cavity into the one or more recess portions when the first mold is moved toward the second mold.
